(19) United States
(12) Patent Application Publication
(10) Pub. No.: US 2010/0086291 A1
(43) Pub. Date: Apr. 8, 2010

(54) CAMERA MODULE AND DRIVING METHOD THEREOF

(76) Inventors: Yang Seub KIM, Bucheon-si (KR); Soon Cheol Cho, Seoul (KR); Young Hun Lee, Nonsan-si (KR)

Correspondence Address: North Star Intellectual Property Law, PC, P.O. Box 34688, Washington DC, DC, 20043, US

(21) Appl. No.: 12/571,520

(22) Filed: Oct. 1, 2009

(30) Foreign Application Priority Data
Oct. 2, 2008 (KR) 10-2008-0097324
Oct. 9, 2008 (KR) 10-2008-0099116

(51) Int. Cl. G02B 7/04; G03B 17/00

(52) U.S. Cl. 396/79; 396/144

(57) ABSTRACT

Provided are a camera module and driving method thereof. The camera module includes first and second lens assemblies, and a power transmission member. The power transmission member includes a screw thread having a variable pitch for a distance between the first and second lens assemblies to be varied as the first and second lens assemblies move in engagement with the screw thread.

### CROSS-REFERENCE TO RELATED APPLICATIONS

This application claims priority under 35 U.S.C. §119 to Korean Patent Application No. 10-2008-0097324, filed on Oct. 2, 2008, and Korean Patent Application No. 10-2008-0099116, filed on Oct. 9, 2008, the disclosures of which are incorporated herein by reference in its entirety.

### TECHNICAL FIELD

The present disclosure relates to a camera module and a driving method thereof, and in particular, to a camera module and a driving method thereof, which can be miniaturized and lightened.

### BACKGROUND

Recently, imaging apparatuses such as digital still cameras and digital video cameras are widely supplied. Such an imaging apparatus includes an optical system including a lens unit, an imaging device which is disposed at the one surface of the lens unit, a picture processing unit which processes an electrical signal received from the imaging device, and a memory which stores a photographed picture. The operation of the imaging apparatus is performed as follows. That is, when a user photographs an image, the image light of a subject that is transmitted through the lens unit is incident on the imaging device such as Charge Coupled Devices (CCD), and the imaging device converts the incident image light into an electrical picture signal. The picture processing unit processes the picture signal, and the memory stores the photographed picture, thereby performing photographing.

For photographing a subject at a wider angle than a standard angle or zooming and photographing a far subject according to a user's convenience, a zoom lens assembly is required. For focusing the subject, a lens assembly for focusing is required.

A related art imaging apparatus includes a motor for driving a zoom lens assembly, and a motor for driving a lens assembly for focusing. That is, the related art imaging apparatus includes the two motors. Moreover, the related art imaging apparatus includes a gear unit for supplying the power of the each motor to the lens assembly. In this case, however, the volume of a camera module enlarges. Moreover, because of driving the two motors, power consumption is very high.

### SUMMARY

Accordingly, the present disclosure provides a camera module and a driving method thereof, which can be miniaturized.

The present disclosure also provides a camera module and a driving method thereof, which can be lightened.

The objects of the present invention are not limited to the above-described object, and the objects and advantages of the present invention other than the above-described object can be understood by description below and will be more apparent with reference to the embodiments of the present invention.

In one general aspect, a camera module includes: a first lens assembly; a second lens assembly; a power transmission member in which a screw thread having a variable pitch is formed for a distance between the first and second lens assemblies to be varied as the first and second lens assemblies move in engagement with the screw thread.

In another general aspect, a camera module includes: a first lens assembly; a second lens assembly; a driving motor supplying a power; a first power transmission member including a first screw thread having a first pitch, and receiving a power of the driving motor to move the first lens assembly engaging with the first screw thread; and a second power transmission member including a second screw thread having a second thread different from the first pitch, and receiving a power of the driving motor to move the second lens assembly engaging with the second screw thread for a distance between the first and second lens assemblies to be varied.

In another general aspect, a camera module includes: a lens assembly for zooming; a lens assembly for focusing; a cam rotating by a power in engagement with the lens assembly for zooming and the lens assembly for focusing to move the lens assembly for zooming and the lens assembly, and in which a screw thread having a variable pitch is formed for a distance between the lens assembly for zooming and the lens assembly to be varied; and a driving motor supplying the power to rotate the cam.

In another general aspect, a driving method of a camera module includes: simultaneously moving a lens assembly for zooming and a lens assembly for focusing through one driving motor, wherein the lens assembly for zooming and the lens assembly are moved for a distance between the lens assembly for zooming and the lens assembly to be varied; and minutely moving a lens for focusing of the lens assembly for focusing to align a focus.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a perspective view illustrating a camera module according to an exemplary embodiment.

FIGS. 2 and 3 are perspective views illustrating a camera module in which a housing is removed from the camera module of FIG. 1.

FIG. 4 is a plan view illustrating the camera module of FIG. 3.

FIG. 5 is a graph illustrating the movement locuses of first and second lens assemblies.

FIGS. 6 and 7 are perspective views illustrating a shape in which the lens of a second lens assembly minutely moves according to a voice coil motor.

FIG. 8 is a plan view for describing a camera module according to another exemplary embodiment.

FIG. 9 is a perspective view illustrating a camera module according to another exemplary embodiment.

FIG. 10 is a magnified diagram magnifying a portion A in FIG. 9 from a specific perspective.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. Like reference numerals refer to like elements throughout.

A camera module according to an exemplary embodiment moves a first lens assembly and a second lens assembly through one power transmission member. At this point, the distance between the first and second lens assemblies may be varied. Herein, the first lens assembly may be a lens assembly for zooming, and the second lens assembly may be a lens assembly for focusing. A screw thread having a variable pitch may be formed in the power transmission member, and the first and second lens assemblies may engage with the screw thread and thereby move.

Alternatively, the camera module moves the first lens assembly and the second lens assembly through one driving motor. At this point, the distance between the first and second lens assemblies may be varied. Herein, the first lens assembly may be a lens assembly for zooming, and the second lens assembly may be a lens assembly for focusing. For transmitting a power from one driving motor, one power transmission member may be used, or two power transmission members may be used. Herein, a screw thread may be formed in the power transmission member. In a case where one power transmission member is included, the pitch of a screw thread may be variable. In a case where two power transmission members are included, the screw threads of the two power transmission members have a constant pitch but may have different pitches.

Hereinafter, exemplary embodiments will be described in detail with reference to the accompanying drawings.

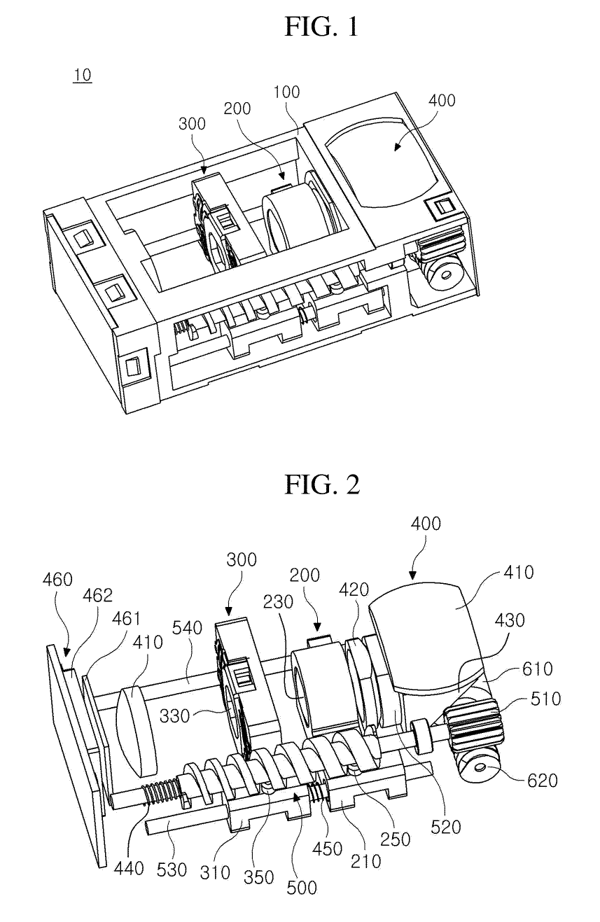

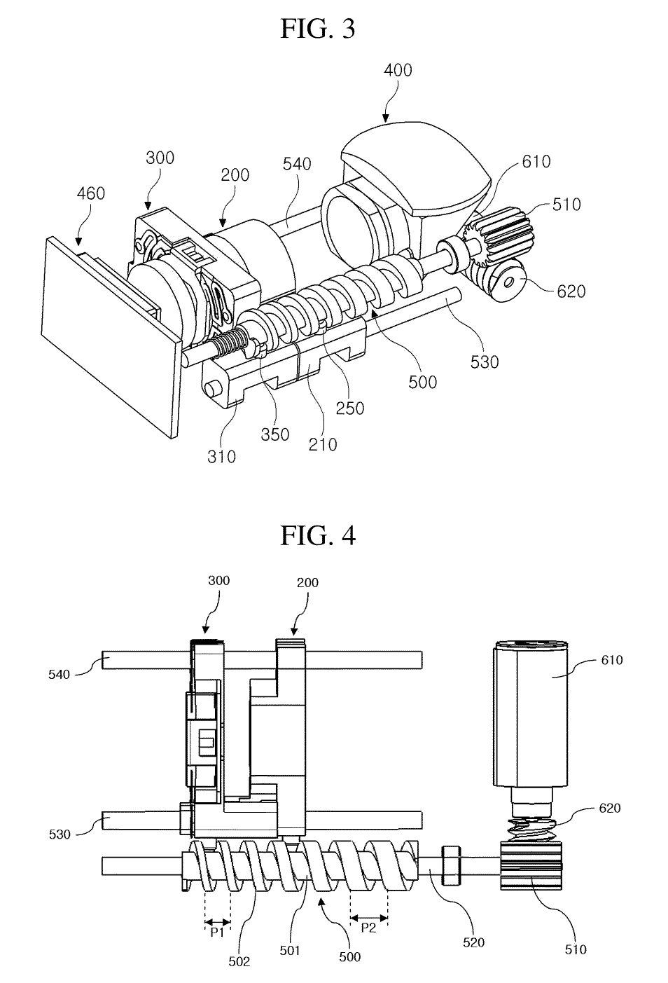

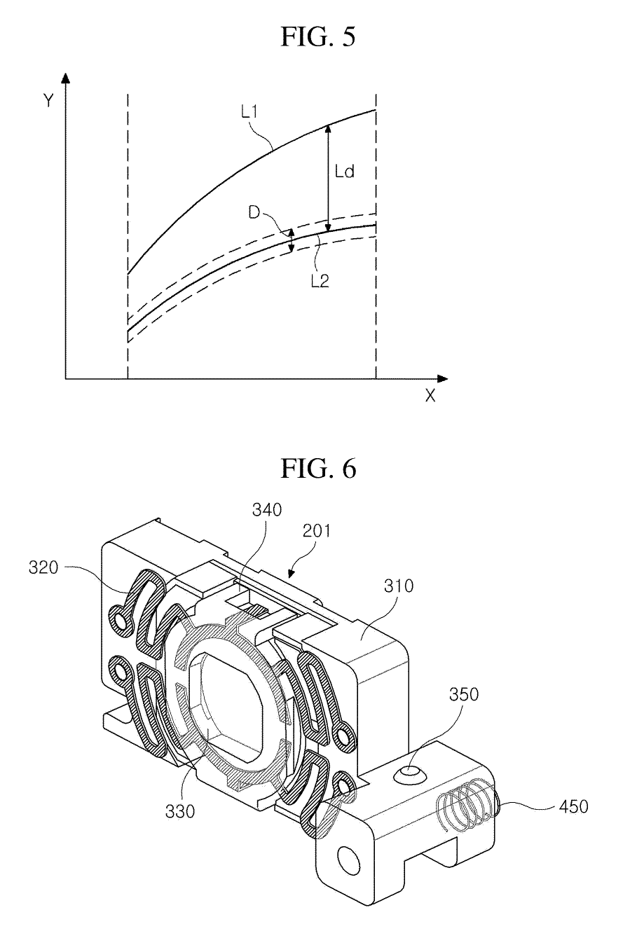

A camera module and driving method thereof according to an exemplary embodiment will be described below with reference to FIGS. 1 to 5. FIG. 1 is a perspective view illustrating a camera module according to an exemplary embodiment. FIGS. 2 and 3 are perspective views illustrating a camera module in which a housing is removed from the camera module of FIG. 1. FIG. 4 is a plan view illustrating the camera module of FIG. 3. FIG. 5 is a graph illustrating the movement locuses of first and second lens assemblies.

Referring to FIGS. 1 to 4, a camera module 10 according to an exemplary embodiment includes a housing 100 loading and covering each element, a first lens assembly 200, a second lens assembly 300, a third lens assembly 400, a driving motor 610 and a power transmission member 500.

The first and second lens assemblies 200 and 300 include lens barrels 210 and 310, and lenses 230 and 330, respectively. Herein, the first lens assembly 200 may be a lens assembly for zooming for zooming and photographing a far subject, and the second lens assembly 300 may be an auto focusing-enabled lens assembly for focusing. The first and second lens assemblies 200 and 300 are linked and thereby move together or simultaneously. In movement, the distance between the first and second lens assemblies 200 and 300 may be varied. The operations of the first and second lens assemblies 200 and 300 will be described below in detail.

The third lens assembly 400 includes a plurality of lenses 410 and 420, and a prism 430 which changes the traveling direction of light by 90 degrees in order for light incident on the lens 410 to travel to the lens 420.

The number of lenses included in the lens assemblies 200, 300 and 400 may be different. Moreover, a shutter (not shown) and a diaphragm (not shown) may be disposed between the first and second lens assemblies 200 and 300.

The camera module 10 may further include a hemisphere lens 410 and an optical-to-electrical converter 460. The optical-to-electrical converter 460 may be an Optical Low Pass Filter (OLPF) 461 and a CCD 462. The CCD 462 converts light passing through the lenses into an electrical signal, and a Complementary Metal Oxide Semiconductor (CMOS) may be used instead of the CCD 462.

The first and second lens assemblies 200 and 300 are disposed to move inside the housing 100 along two guide bars 530 and 540 that are disposed across in the housing 100. For this, grooves are formed in the barrel 210 of the first lens assembly 200 and the barrel 310 of the second lens assembly 300, respectively. The guide bars 530 and 540 are inserted to pass through the grooves, respectively. For moving the first and second lens assemblies 200 and 300, the driving motor 610 and the power transmission member 500 are included. Herein, the power transmission member 500, for example, may be a cam. A case in which the power transmission member is a cam 500 will be described below through an example, but it is not limited thereto.

To provide more detailed description on an operation, when the driving motor 610 supplies a power, a worm gear 620 and a worm 510 transmit the power of the driving motor 610 to the cam 500. That is, the work gear 620 and the worm 510 rotate the cam 500 to be vertical with the rotation direction of the driving motor 610. When the cam 500 rotates by the power of the driving motor 610 that is transmitted, the first and second lens assemblies 200 and 300 that engage with the cam 500 perform a straight-line motion along the guide bars 530 and 540. For this, barrel protrusions 250 and 350 are included in the barrel 210 of the first lens assembly 200 and the barrel 310 of the second lens assembly 300, respectively. The barrel protrusions 250 and 350 engage with the cam groove 510 of the cam 500. Accordingly, the first and second lens assemblies 200 and 300 are linked and move to the one driving motor 610.

A first elastic member 440, for example, a spring is inserted into a rotation axis 520, thereby preventing the shake of the rotation axis 520. That is, by applying an elastic force from the housing 100 to the rotation axis 520, the first elastic member 440 prevents the shake of the rotation axis 520.

A second elastic member 450 may be included between the first and second lens assemblies 200 and 300. For example, a spring 450 is inserted into the guide bars 530 and 540 and may be included between the barrel 210 of the first lens assembly 200 and the barrel 310 of the second lens assembly 300. In this case, the first and second lens assemblies 200 and 300 are pushed in opposite directions by an elastic force, and therefore the barrel protrusion 250 of the barrel 210 and the barrel protrusion 350 of the barrel 310 engage with the cam groove 501 of the cam 500, decreasing the movement of the first and second lens assemblies 200 and 300.

The distance between the first and second lens assemblies 200 and 300 may be varied in movement. That is, because the pitch of the cam 500 is not constant and is variably formed, the distance between the first and second lens assemblies 200 and 300 that engage with the cam 500 to move may be varied according to the pitch of the cam 500.

To provide a detailed description with reference to FIG. 4, the pitches P1 and P2 of the cam 500 is variable. The pitches P1 and P2 may be defined as the movement distances of the first and second lens assemblies 200 and 300 engaging with the cam 500 or the distance from a screw thread 502 to another screw thread 502 (wherein the screw threads 502 are formed at the cam 500), when the cam 500 rotates. In FIG. 4, as the length of the screw thread 502 is variably formed, an example in which the pitch P2 is greater than the pitch P1 is illustrated. That is, the pitch of the cam 500 near to the driving motor 610 is greater than the pitch of the cam 500 far from the driving motor 610. Accordingly, when the first and second lens assemblies 200 and 300 move toward the driving motor 610, the movement distance of the first lens assembly 200 becomes greater than the movement distance of the second lens assembly 300, and thus the distance between the first and second lens assemblies 200 and 300 widens gradually.

The movements of the first and second lens assemblies 200 and 300 are illustrated in FIG. 5. In FIG. 5, that is, an X-axis represents a rotation time in the one direction of the driving motor 610 (wherein the one direction denotes the rotation direction of the driving motor 610 that allows the first and second lens assemblies 200 and 300 to move toward the driving motor 610), and a Y axis represents the positions of the first and second lens assemblies 200 and 300 from a certain reference position (for example, from the optical-to-electrical converter 420 in FIG. 2). A first locus L1 represents one in which the first lens assembly 200 moves, and a second locus L2 represents one in which the second lens assembly 300 moves.

As illustrated in FIG. 5, as the driving motor 610 rotates in one direction, when the cam 500 rotates and thereby the first and second lens assemblies 200 and 300 move toward the driving motor 610, the first and second lens assemblies 200 and 300 move along the different locuses L1 and L2. At this point, the distance Ld between the first and second lens assemblies 200 and 300 widens gradually.

Herein, the first and second locuses L1 and L2 may be predetermined to have a certain relationship. Accordingly, the cam 500 having the variable pitches P1 and P2 may be fabricated to move the first and second lens assemblies 200 and 300.

To provide a description through an example, the first lens assembly 200 may be a lens assembly for zooming, and the first locus L1 may be the movement locus of the lens assembly for zooming. Moreover, the second lens assembly 300 may be a lens assembly for focusing, and the second locus L2 may be the movement locus of the lens assembly for focusing. The position relationship of the lens assembly 300 for focusing with respect to the lens assembly 200 for zooming may be predetermined. That is, by experimentally calculating the position of the lens assembly for zooming capable of focusing a subject and the distance (which is based on the position) between the lens assembly 200 for zooming and the lens assembly 300 for focusing, the first and second locuses L1 and L2 can be predetermined. The variable pitches P1 and P2 are calculated for the lens assembly 200 for zooming and the lens assembly 300 to move along the predetermined first and second locuses L1 and L2, and the cam 500 having the pitches P1 and P2 may be fabricated.

Herein, in a case where it is required to focus more accurately, i.e., a case where it is not desired to focus by a certain degree but desired to more minutely focus when the lens assembly 300 for focusing moves along the second locus L2, it is required to minutely move the lens assembly 300 for focusing. In this case, the lens 330 for focusing (see FIG. 6) of the lens assembly 300 for focusing may be minutely moved through a Voice Coil Motor (VCM).

Referring to FIG. 5, that is, when the lens assembly 300 for focusing moves along the second locus L2, the lens 330 for focusing (see FIG. 6) may be minutely moved within a minute distance D through the VCM.

In other words, when a user aligns zooming, the lens assembly 200 for zooming and the lens assembly 300 for focusing move on the first and second locuses L1 and L2 by the driving motor 610 and the cam 500, respectively. When zooming is aligned, the lens 300 for focusing minutely moves through the VCM to accurately align the focus of a subject.

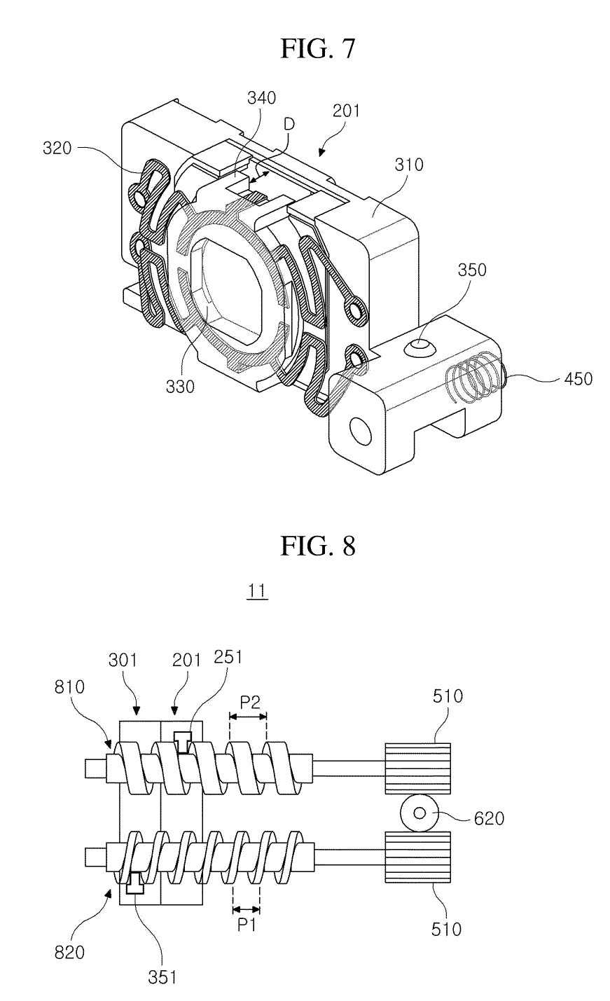

Hereinafter, the second lens assembly 300 including the VCM will be described with reference to FIGS. 6 and 7. FIGS. 6 and 7 are perspective views illustrating a shape in which the lens of the second lens assembly 300 minutely moves according to the VCM.

Referring to FIG. 6, the second lens assembly 300 includes the barrel 310, the barrel protrusion 350 engaging with the cam 500, the lens 300 for focusing, a supporter 340 supporting the lens 330 for focusing, and a voice coil 320 which is coupled with the supporter 340 for minutely moving the lens 330 for focusing with an electromagnetic force.

FIG. 6 illustrates a shape in which electricity is not supplied to the voice coil 320, and FIG. 7 illustrates a shape in which electricity is supplied to the voice coil 320. That is, when electricity is supplied to the voice coil 320, the voice coil 320 moves by an electromagnetic force, whereupon the supporter 340 coupled with the voice coil 320 moves and thereby the lens 330 for focusing moves by the minute distance D.

The voice coil 320 may be provided in an integrated structure in which it is integrated with the supporter 340. For example, when injection-molding the supporter 340, the supporter 340 may be fabricated in an integrated structure by inserting the voice coil 320. A method for fabricating a VCM and the shape and structure of the VCM are not limited to one embodiment.

To provide a brief description, the camera module 10 according to an exemplary embodiment may move the first and second lens assemblies 200 and 300 through the one driving motor 610. At this point, the first and second lens assemblies 200 and 300 may move along different locuses, and in movement, the distance between the first and second lens assemblies 200 and 300 may be varied. For this, one cam having a variable pitch may be used. Accordingly, the size of the camera module 10 can be reduced and lightened. Alternatively, since the one driving motor 610 is used, power consumption can decrease. Since the first and second lens assemblies 200 and 300 move at the same time, a driving speed can improve.

Hereinafter, a camera module and driving method thereof according to another exemplary embodiment will be described with reference to FIG. 8. FIG. 8 is a plan view for describing a camera module according to another exemplary embodiment. In FIG. 8, for convenience, only elements different from those of the camera module according to an exemplary embodiment are illustrated.

Referring to FIG. 8, unlike an exemplary embodiment, a camera module 11 according to another exemplary embodiment includes a worm gear 620 that transmits a power from one driving motor, two worms 510 that rotate in engagement with the worm gear 620, and two power transmission members 810 and 820 that receive the power to move the lens assemblies 201 and 301. Hereinafter, a case in which the power transmission members 810 and 820 are cams will be described through an example, but it is not limited thereto.

A first lens assembly 201 engages with a first cam 810, and a second lens assembly 301 engages with a second cam 820. That is, the barrel protrusion 251 of the first lens assembly 201 engages with the cam groove of the first cam 810, and the barrel protrusion 351 of the second lens assembly 301 engages with the cam groove of the second cam 820. The first and second cams 810 and 820 are respectively provided to have certain pitches P2 and P1, but the pitch P2 of the first cam 810 differs from the pitch P1 of the second cam 820. For example, the pitch P2 of the first cam 810 is greater than the pitch P1 of the second cam 820. However, because the two worms 510 are the same, the first and second cams 810 and 820 may rotate the same number of times according to the rotation of the driving motor 610.

When the driving motor 610 rotates, the first and second cams 810 and 820 rotate according to the worm gear 620 and the two worms 510 that engage with the worm gear 620 to rotate, whereupon the first and second lens assemblies 201 and 301 move. Herein, since the pitch P2 of the first cam 810 is greater than the pitch P1 of the second cam 820, the distance between the first and second cams 810 and 820 gradually widens in movement. That is, the first and second lens assemblies 201 and 301 may move identically to the locuses of FIG. 5.

That is, the camera module 11 uses one driving motor 610 but moves the first and second lens assemblies 201 and 301 along different locuses by the use of the two cams. Herein, each of the two cams has one pitch, but since the pitches are different, the distance between the first and second lens assemblies 201 and 301 may be varied in movement. The camera module 11 uses the one driving motor 610, thereby lightening and miniaturizing the camera module 11.

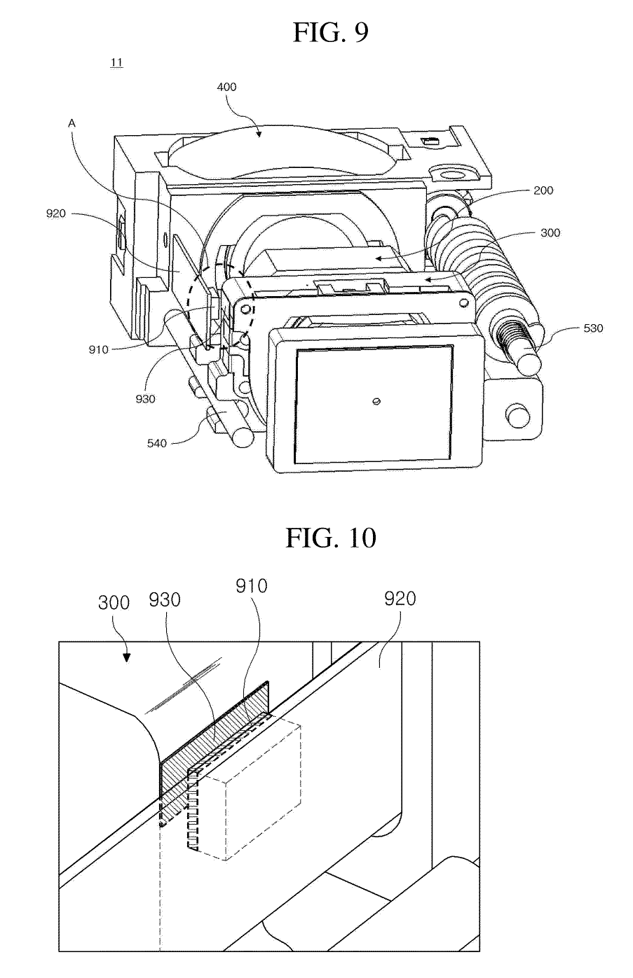

A camera module and driving method thereof according to another exemplary embodiment will be described below with reference to FIGS. 9 and 10. FIG. 9 is a perspective view illustrating a camera module according to another exemplary embodiment. FIG. 10 is a magnified diagram magnifying a portion A in FIG. 9 from a specific perspective.

Referring to FIGS. 9 and 10, a camera module 12 according to another exemplary embodiment further includes a sensor 910 which senses the position of a second lens assembly 300.

The sensor 910 is mounted on a printed circuit board (PCB) 920, and the PCB 920 may be provided to be fixed in the housing 100 (see FIG. 1). When the second lens assembly 300 is disposed at a position farthest away from or nearest to the third lens assembly 400 among positions in which it may move along the guide bars 530 and 540 by the driving motor 610, the sensor 910 may be provided for sensing whether the second lens assembly 300 is disposed at the position. In FIGS. 9 and 10, a case, in which the sensor 910 is provided to sense whether the second lens assembly 300 is disposed at a position farthest away from the third lens assembly 400, is illustrated as an example. Hereinafter, the positions of the first and second lens assemblies 200 and 300 farthest away from the third lens assembly 400 are referred to as initial positions. Accordingly, the sensor 910 produces light or rays (for example, infrared rays or ultraviolet rays), and by sensing whether the produced light or rays is reflected back by the reflector 930 of the second lens assembly 300 or is reflected back within a certain time, the sensor 910 senses whether the first and second lens assemblies 200 and 300 are at the initial position.

Such a sensor 910 may be applied to the following case.

When the driving motor 610 rotates, the first and second lens assemblies 200 and 300 move. At this point, the rotation number of the driving motor 610 is prestored in a memory (not shown), and therefore the camera module 12 may know the current positions of the first and second lens assemblies 200 and 300 on the basis of the rotation number of the driving motor 610. Subsequently, if the camera module 12 is turned off, it moves the first and second lens assemblies 200 and 300 into the initial positions on the basis of the rotation number of the driving motor 610 that is prestored in the memory (not shown). At this point, the sensor 910 may sense the first and second lens assemblies 200 and 300 to check whether the first and second lens assemblies 200 and 300 return to the initial position. Alternatively, when the camera module 12 is initialized, i.e., when a power source is turned on, the sensor 910 may check whether the first and second lens assemblies 200 and 300 are at the initial position.

Alternatively, the sensor 910 may be used to set the driving range of the driving motor 610. That is, the camera module 12 may check whether the first and second lens assemblies 200 and 300 may be moved into a position farthest away from the third lens assembly 400 when the driving motor 610 rotates a certain number of times. That is, the camera module 12 may know whether the first and second lens assemblies 200 and 300 are at the initial position when the driving motor 610 rotates a certain number of times. Measuring the rotation number of the driving motor 610 until the sensor 910 senses the first and second lens assemblies 200 and 300, the driving motor 610 drives within the number of rotation times.

Herein, as described above, since the first and second lens assemblies 200 and 300 move so that the distance between the first and second lens assemblies 200 and 300 may be varied by the one driving motor 610, the camera module 12 may know whether the first and second lens assemblies 200 and 300 are at the initial position when sensing only any one of the positions of the first and second lens assemblies 200 and 300. Accordingly, the camera module 12 may sense the positions of the first and second lens assemblies 200 and 300 only with the sensor 910. When there are two motors that respectively drive the first and second lens assemblies 200 and 300, the number of the senor 910 is required in two equal to the number of motors. According to another exemplary embodiment, however, since the positions of the first and second lens assemblies 200 and 300 may be sensed through only the sensor 910, the lightening, miniaturizing and effective-cost of the camera module can be achieved.

In this embodiment, a case in which the sensor 910 senses the second lens assembly 300 has been described above as an example, but it is not limited thereto. It is apparent that the sensor 910 may be provided to include the first lens assembly 200. In this case, the reflector 930 may be included in the first lens assembly 200.

According to exemplary embodiments, the camera module can be miniaturized. Moreover, the camera module can be lightened.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A camera module, comprising:
a first lens assembly;
a second lens assembly;
a power transmission member in which a screw thread having a variable pitch is formed for a distance between the first and second lens assemblies to be varied as the first and second lens assemblies move in engagement with the screw thread.

2. The camera module of claim 1, wherein the power transmission member moves the first and second lens assemblies along different locuses.

3. The camera module of claim 1, wherein the power transmission member moves the first and second lens assemblies for the distance between the first and second lens assemblies to gradually widen or narrow.

4. The camera module of claim 1, wherein:
the first lens assembly is a lens assembly for zooming, and
the second lens assembly is a lens assembly for focusing.

5. The camera module of claim 4, wherein the second lens assembly comprises:
a lens for focusing; and
a voice coil motor minutely moving the lens for focusing.

6. The camera module of claim 1, further comprising a driving motor supplying a power to the power transmission member.

7. The camera module of claim 6, wherein the driving motor rotates the power transmission member through a worm gear.

8. The camera module of claim 1, wherein the power transmission member is a cam.

9. A camera module, comprising:
a first lens assembly;
a second lens assembly;
a driving motor supplying a power;
a first power transmission member comprising a first screw thread having a first pitch, and receiving a power of the driving motor to move the first lens assembly engaging with the first screw thread; and
a second power transmission member comprising a second screw thread having a second thread different from the first pitch, and receiving a power of the driving motor to move the second lens assembly engaging with the second screw thread for a distance between the first and second lens assemblies to be varied.

10. The camera module of claim 9, wherein the first and second power transmission members move the first and second lens assemblies along different locuses, respectively.

11. The camera module of claim 9, wherein the first and second power transmission members move the first and second lens assemblies for the distance between the first and second lens assemblies to gradually widen or narrow.

12. The camera module of claim 9, wherein:
the first lens assembly is a lens assembly for zooming, and
the second lens assembly is a lens assembly for focusing.

13. The camera module of claim 12, wherein the second lens assembly comprises:
a lens for focusing; and
a voice coil motor for minutely moving the lens for focusing.

14. The camera module of claim 9, wherein the first and second power transmission members are cams.

15. A camera module, comprising:
a lens assembly for zooming;
a lens assembly for focusing;
a cam rotating by a power in engagement with the lens assembly for zooming and the lens assembly for focusing to move the lens assembly for zooming and the lens assembly, and in which a screw thread having a variable pitch is formed for a distance between the lens assembly for zooming and the lens assembly to be varied; and
a driving motor supplying the power to rotate the cam.

16. The camera module of claim 15, wherein the lens assembly for zooming and the lens assembly for focusing move along different locuses.

17. The camera module of claim 15, wherein the lens assembly for focusing comprises:
a lens for focusing; and
a voice coil motor minutely moving the lens for focusing.

18. The camera module of claim 15, further a driving motor supplying the power to the cam.

19. A driving method of a camera module, the driving method comprising:
simultaneously moving a lens assembly for zooming and a lens assembly for focusing through one driving motor, wherein the lens assembly for zooming and the lens assembly are moved for a distance between the lens assembly for zooming and the lens assembly to be varied; and
minutely moving a lens for focusing of the lens assembly for focusing to align a focus.

20. The driving method of claim 19, wherein the moving of a lens assembly comprises moving the lens assembly for zooming and the lens assembly for focusing on different locuses.

21. The driving method of claim 19, wherein the moving of a lens assembly comprises receiving a power from the driving motor to move the lens assembly for zooming and the lens assembly for focusing through a cam which engages with the lens assembly for zooming and the lens assembly for focusing, wherein the cam has a variable pitch.
